(19) United States
(12) Patent Application Publication
(10) Pub. No.: US 2010/0295839 A1
(43) Pub. Date: Nov. 25, 2010

(54) Image Display Device

(75) Inventors: Shigeki Nagaya, Hamamatsu-shi (JP); Tomoaki Yoshinaga, Sagamihara (JP); Takehiro Fujita, Hamura (JP); Hiroaki Ito, Kawasaki (JP); Katsuyuki Watanabe, Mito (JP); Hidekazu Takeda, Hiratsuka (JP); Maki Furui, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Consumer Electronics Co., Ltd., Tokyo (JP)

(21) Appl. No.: 12/782,421

(22) Filed: May 18, 2010

(30) Foreign Application Priority Data
May 19, 2009 (JP) 2009-120472

(51) Int. Cl. G06F 3/038; G06T 7/00

(52) U.S. Cl. 345/212; 382/103

(57) ABSTRACT

Disclosed is an image display device that provides power consumption reduction control in an improved manner. The image display device includes an input that inputs a video signal, an output controller that reproduces the video signal entered into the input, a display that displays an image in accordance with the video signal reproduced by the output controller, an imager that picks up an image of a user of the image display device, an attentiveness decider that analyzes the image picked up by the imager and judges whether the user is watching a display screen of the display, and a controller that selects either a normal mode or a power saving mode as a processing mode for light intensity control of a light source of the display or for reproduction in the output controller in accordance with the result of decision made by the attentiveness decider.

### CLAIM OF PRIORITY

The present application claims priority from Japanese patent application JP2009-120472 filed on May 19, 2009, the content of which is hereby incorporated by reference into this application.

### BACKGROUND OF THE INVENTION

The present invention relates to a technology that controls an image display device in accordance with a user's state that is calculated from an image picked up by an imager and the result of sensor detection.

As a technology for controlling an image display device in accordance with a user's state that is calculated from an image picked up by an imager and the result of sensor detection, a viewer position detection unit is disclosed, for instance, in paragraph 0017 of Japanese Patent Application Laid-Open Publication No.2008-244917. The viewer position detection unit detects the viewer's position by detecting the face or neck portion of a viewer image picked up by an imaging unit as a flesh color and determining the spatial position of the detected flesh color within an image pattern. A viewer state detection unit is disclosed in paragraph 0020. To determine whether the viewer is awake or asleep, the viewer state detection unit acquires the information about the viewer's state by detecting the motions of the viewer's eyeballs and pupils picked up by the imaging unit. A power consumption reduction method is disclosed in paragraph 0032. When the viewer leaves a visible region, this power consumption reduction method uses the viewer position detection unit to detect the resulting state in accordance with outputs of human sensors and causes an image receiver control unit to gradually decrease the brightness of the screen of an image display unit. A power saving method of minimizing the power consumption while the viewer is asleep is disclosed in paragraph 0035. When the viewer state detection unit detects that the viewer is asleep because the viewer's pupils are motionless or invisible within a picked-up image, this power saving method causes the image receiver control unit to decrease the brightness of the image display unit and, if necessary, turn off an image receiver.

In reality, however, the user of the image display device may be watching the display screen of the image display device even when the user is away from the image display device. Further, the user may not be watching the display screen of the image display device even when the pupils of the user of the image display device are visible to the imager. In such instances, the technology disclosed in Japanese Patent Application Laid-Open Publication No. 2008-244917 is incapable of exercising proper power consumption reduction control because it may decrease the screen brightness while the user is watching the display screen or fail to decrease the screen brightness while the user is not watching the display screen.

The present invention has been made in view of the above circumstances and provides power consumption reduction control in an improved manner.

### SUMMARY OF THE INVENTION

For example, an embodiment of the present invention can be configured as defined in the appended claims to address the above circumstances.

The present invention makes it possible to provide power consumption reduction control in an improved manner.

### BRIEF DESCRIPTION OF THE DRAWINGS

Embodiments of the present invention will be described in detail based on the following figures, wherein:

FIG. 1 shows an image display device according to an embodiment of the present invention and a typical system for such an image display device;

FIG. 2 shows an example of backlight control that is exercised on the basis of attentiveness decision according to an embodiment of the present invention;

FIG. 3 is a diagram illustrating a typical configuration of the image display device according to an embodiment of the present invention;

FIG. 4 is a diagram illustrating a typical configuration of an attentiveness recognizer according to an embodiment of the present invention;

FIG. 5 is a diagram illustrating a typical configuration of a power saving controller according to an embodiment of the present invention;

FIG. 6 shows a typical configuration of a display panel according to an embodiment of the present invention;

FIG. 7 is a diagram illustrating typical configurations of the display panel and a panel controller according to an embodiment of the present invention;

FIG. 8 is a diagram illustrating an example of an audio/video output controller according to an embodiment of the present invention;

FIG. 9 is a diagram illustrating an example of video output control by the audio/video output controller according to an embodiment of the present invention;

FIG. 10 is a diagram illustrating an example of an image recognizer according to an embodiment of the present invention;

FIG. 11 is a diagram illustrating an example of caption display control according to an embodiment of the present invention;

FIG. 12 is a flowchart illustrating an example of a power saving mode selection sequence according to an embodiment of the present invention;

FIG. 13 is a flowchart illustrating an example of an attentiveness decision sequence according to an embodiment of the present invention;

FIG. 14 is a flowchart illustrating an example of the attentiveness decision sequence according to an embodiment of the present invention;

FIG. 15 is a flowchart illustrating an example of the attentiveness decision sequence according to an embodiment of the present invention;

FIG. 16 is a diagram illustrating an example of backlight illumination control according to an embodiment of the present invention;

FIG. 17 is a flowchart illustrating an example of backlight illumination control according to an embodiment of the present invention; and

FIG. 18 is a diagram illustrating an example of attentiveness recognition process control according to an embodiment of the present invention.

### DETAILED DESCRIPTION OF THE INVENTION

Embodiments of the present invention will now be described with reference to the accompanying drawings.

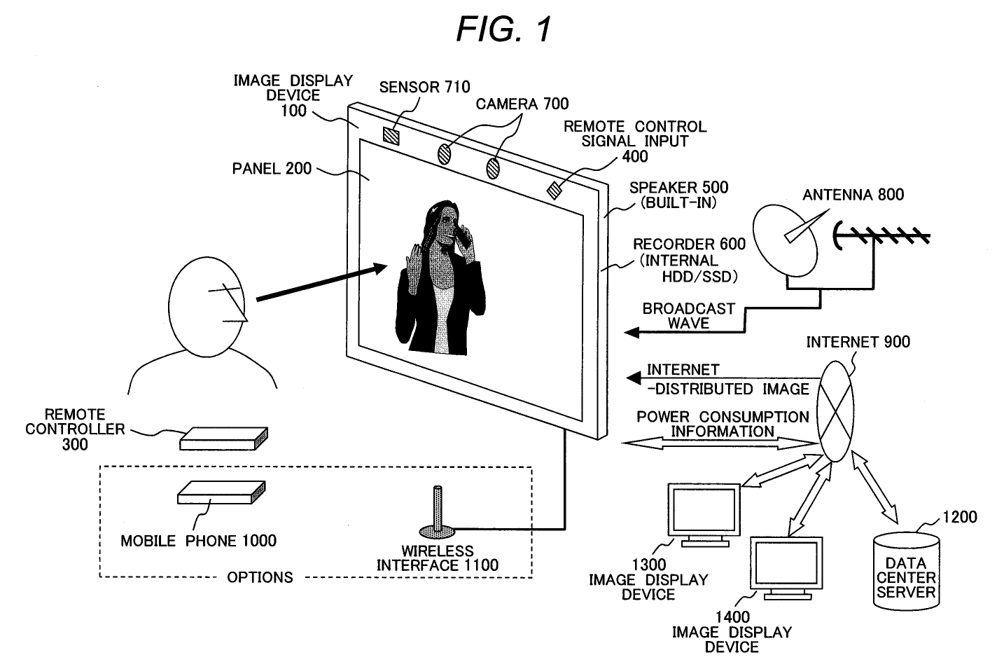

FIG. 1 shows an image display device according to an embodiment of the present invention and a typical system for such an image display device. The image display device according to the present embodiment of the present invention and the system for such an image display device are designed to reduce power consumption by illuminating or extinguishing a backlight and changing the status of image display or audio output as appropriate depending on whether a user is watching the image display device.

The image display device 100 includes a display panel 200, which displays an image, and a speaker 500, which generates an audio output, and reproduces a broadcast wave captured by an antenna 800, a distributed image obtained from the Internet 900, or an image recorded on a recorder 600 having a HDD (Hard Disk Drive) or SSD (Solid State Disk). A user of the image display device 100 uses a remote controller 300 to operate the image display device 100 for the purpose, for instance, of turning on and off the power, adjusting the volume of sound, or switching from one channel to another. A remote control signal input 400 receives an infrared signal from the remote controller 300 and performs a user-specified operation. As an optional device for user operations, a mobile phone 1000 having a Wi-Fi or other wireless LAN function may be used. Operating instructions issued by the mobile phone 100 enter the image display device 100 through a wireless interface 1100.

A camera 700 or a sensor 710 is used to measure the user's state for the purpose of judging whether the user is watching the image display device 100. One or more cameras 700 and sensors 710 may be used depending on what algorithm is employed to judge whether the user is watching the image display device 100. The image display device 100 may include one camera 700 and one sensor 710 or use two or more cameras 700 and sensors 710. In some other case, the image display device 100 may include either one or more cameras 700 or one or more sensors 710. For example, disposing two cameras 700 on the image display device 100 makes it possible to obtain a wide-angle user image and measure the distance between the user and the image display device on the basis of the principle of a triangulation-based stereo camera. When the user image obtained in the above-described manner is subjected to a recognition process in the image display device, it is possible to judge whether the user is watching the image display device and to exercise power saving control by switching, for instance, between a normal mode and a power saving mode.

Further, plural image display devices 1300, 1400 may be connected to a data center 1200 through the Internet 900 to form a power consumption information sharing system that shares the power consumption information (power consumption reduction information) about the individual image display devices 1300, 1400.

More specifically, the plural image display devices within the power consumption information sharing system transmit their respective power consumption information to the data center 1200. The data center 1200 sums up the received respective power consumption information and calculates total power consumption reduction information including the total amount of power consumption reduction and the amount of average power consumption reduction. The data center 1200 then transmits the calculated total power consumption reduction information to the plural image display devices 1300, 1400 through the Internet 900. The plural image display devices 1300, 1400 display the received total power consumption reduction information, thereby allowing the users of the plural image display devices connected to the power consumption information sharing system to share the power consumption reduction amount information about the plural image display devices.

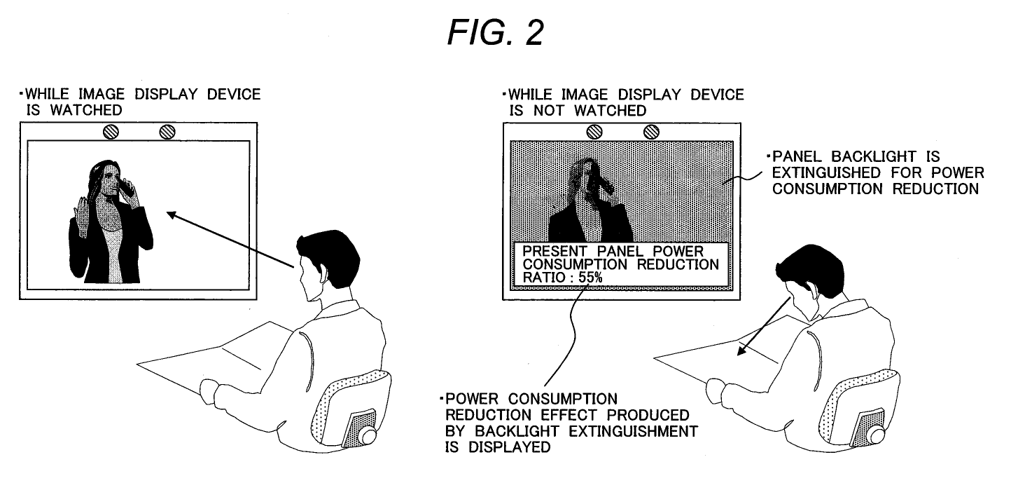

FIG. 2 shows an example of backlight control that is exercised on the basis of attentiveness decision according to the present embodiment of the present invention. In accordance with the user state that is measured by the camera 700 or the sensor 710, the image display device 100 uses a built-in attentiveness decision unit to judge whether the user is watching the image display device. While the user is watching the image display device 100, it outputs video and audio in a normal manner. On the other hand, while the user is not watching the image display device 100, it extinguishes the backlight of the display panel for power consumption saving purposes. In a common situation where the user is viewing the image display device, the user is not always seated in front of the image display device, and not incessantly watching the image display device even when the user is seated in front of the image display device. Even when an image is displayed on the image display device, the user often views the displayed image while being engaged in some other activity. It is said that the period during which the user is viewing the image display device while at the same time being engaged in some other activity is 65% of the time during which an image is displayed on the image display device. The power consumption of the backlight accounts for 80% of the total power consumption of the image display device. When the power consumption of the backlight is reduced during a period during which the user is engaged in an activity other than watching the image display device, the total power consumption of the image display device can be reduced by up to about 50%. Meanwhile, the power consumption of an attentiveness decision process performed by the attentiveness decision unit of the image display device 100 is insignificant because it is as low as about 1 W and equivalent to the power consumption of a commercially available video camera having a face recognition function.

When a power saving state is invoked by extinguishing the backlight, the image display device displays a message indicative of a power consumption reduction effect produced by extinguishing the backlight as shown in the figure. It can therefore be expected that the user will become more oriented toward energy conservation.

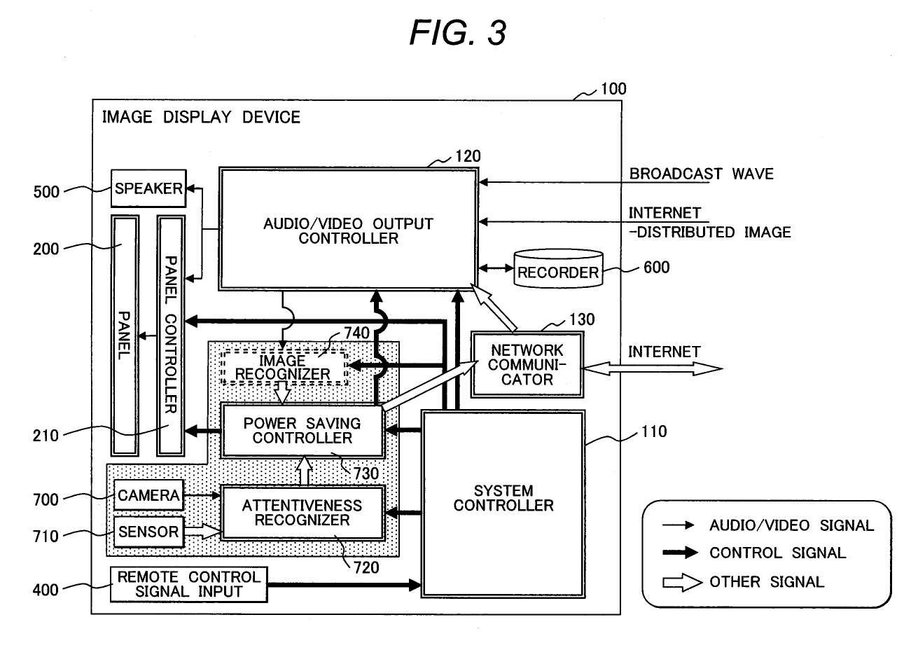

FIG. 3 is a diagram illustrating a typical configuration of the image display device 100 according to the present embodiment of the present invention. The image display device 100 includes not only a basic functional portion but also a unit for measuring the attentiveness of the user and a unit for exercising power saving control in accordance with the measured attentiveness of the user.

The basic functional portion of the image display device is implemented by a system controller 110, an audio/video output controller 120, a display panel 200, a panel controller 210, a speaker 500, a remote control signal input 400, and a recorder 600. The system controller 110 provides overall control of the image display device 100 in accordance with the user's operating instructions input from the remote controller 300 through the remote control signal input 400, for instance, by turning on and off the power, switching between one video source and another, for instance, by selecting a broadcast wave, an image distributed through the Internet, or an image recorded on the recorder 600, and adjusting the volume of sound emitted from the speaker 500. The audio/video output controller 120 decodes an encoded video stream of a user-selected video source and converts the decoded result to an uncompressed audio/video signal. The audio/video signal is output through the display panel 200, panel controller 210, and speaker 500.

The unit for measuring the user's attentiveness includes a camera 700, a sensor 710, and an attentiveness recognizer 720. The camera 700 picks up a user image. The attentiveness recognizer 720 performs a recognition process by using the picked-up image and the information obtained by the sensor 710. In this manner, the unit measures the degree of attention to the image display device.

The unit for exercising power saving control in accordance with the measured attentiveness includes a power saving controller 730 and an image recognizer 740. The image recognizer 740 is an option and need not always be included. The image recognizer 740 recognizes a broadcast image displayed on the display panel, judges whether any information (e.g., the caption to be displayed) should be output in the power saving state, and transmits the result of judgment to the power saving controller 730. The power saving controller 730 provides overall power saving control of the image display device by outputting control commands to the panel controller 210 and the audio/video output controller 120 in accordance with the attentiveness derived from the attentiveness recognizer 720 and caption display positional range information derived from the image recognizer 740.

In addition, the power saving controller 730 measures the amount of power consumption reduction provided by power saving control and stores the measured value as power consumption information. The stored power consumption information is transmitted to the data center 1200 shown in FIG. 1 through a network communicator 130. This enables the data center 1200 to perform a power consumption data collection process for the power consumption information sharing system.

Further, the image display device 100 receives the total power consumption reduction information about the plural image display devices, which is summed up by the data center 1200, from the network communicator 130 through the Internet, causes the audio/video output controller 120 to convert the received total power consumption reduction information to a display image, and displays it on the display panel 200. This permits the user to view, for instance, the total power consumption reduction amount data and average power consumption reduction amount data about the plural image display devices connected to the data center 1200.

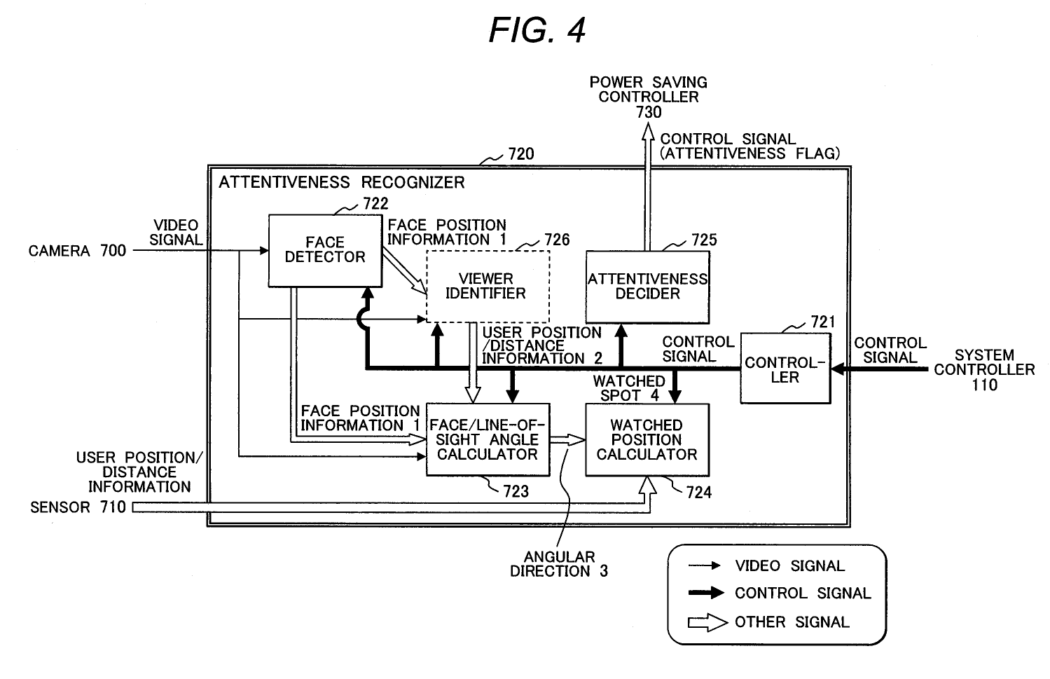

FIG. 4 shows a typical configuration of the attentiveness recognizer 720. The attentiveness recognizer 720 includes a controller 721, a face detector 722, a face/line-of-sight angle calculator 723, a watched position calculator 724, an attentiveness decider 725, and a viewer identifier 726. The viewer identifier 726 is an option and need not always be included. The attentiveness recognizer 720 receives a control signal from the system controller 110, a video signal from the camera 700, and distance information from the sensor 710, and outputs an attentiveness flag to the power saving controller 730 as a control signal.

The face detector 722 detects a face region of the user from the video signal input from the camera 700, and outputs resultant face position information 1 to the face/line-of-sight angle calculator 723 and the viewer identifier 726. The face/line-of-sight angle calculator 723 calculates the angular direction 3 of the face or line-of-sight from the input face position information 1 and video signal, and outputs the calculation result to the watched position calculator 724. The watched position calculator 724 calculates a watched spot 4 in the direction toward an image display device from the angular direction 3 of the user's face or line-of-sight and from the user position/distance information 2, and outputs the calculation result to the attentiveness decider 725. The attentiveness decider 725 compares the watched spot 4 against a predetermined threshold value (the information about a range within which an image display device is judged to be watched). If the threshold value is not exceeded by the watched spot 4, the attentiveness decider 725 outputs an “attentiveness found” flag to the power saving controller 730. If, on the other hand, the threshold value is exceeded by the watched spot 4, the attentiveness decider 725 outputs an “attentiveness not found” flag to the power saving controller 730.

In the present embodiment, all the above-described attentiveness recognition operations are basically performed at a frame rate of the camera (e.g., at a rate of 30 FPS).

The viewer identifier 726 identifies the user, calculates a feature vector for user identification from the face position information input from the face detector 722, and compares the calculated feature vector against a previously extracted feature vector for user tracking purposes. This makes it possible to sum up the viewing history of each user and automatically adjust attentiveness decision parameters of each other.

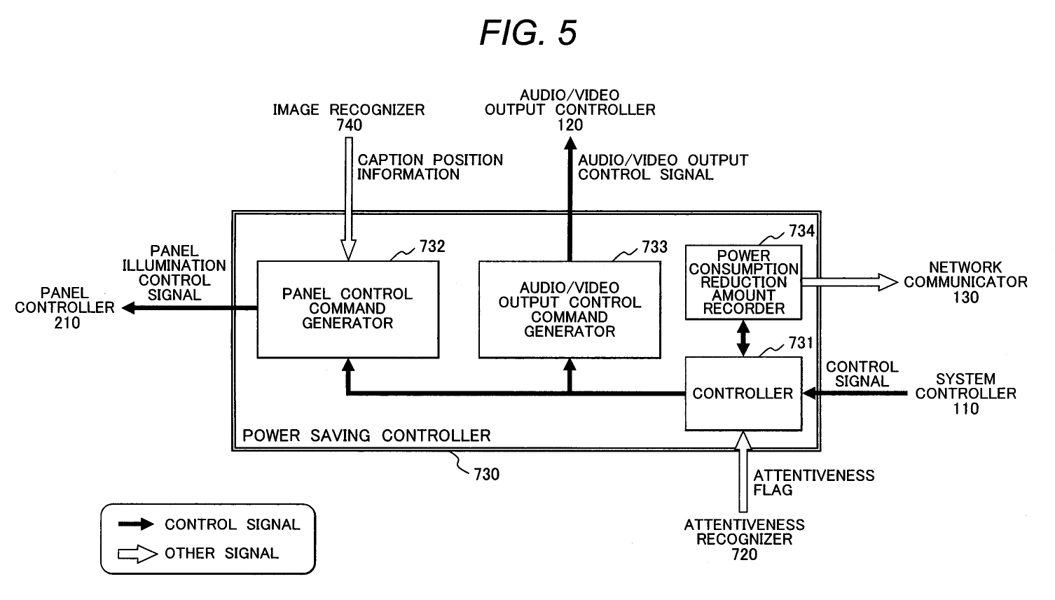

FIG. 5 shows a typical configuration of the power saving controller 730. The power saving controller 730 includes a controller 731, a panel control command generator 732, an audio/video output control command generator 733, and a power consumption reduction amount recorder 734. The power saving controller 730 receives a control command from the system controller 110, an attentiveness flag from the attentiveness recognizer 720, and caption display positional range information from the image recognizer 740, and outputs a panel illumination control command to the panel controller 210 and an audio/video output control signal to the audio/video output controller 120. In addition, the power saving controller 730 calculates the amount of power consumption reduction and outputs the calculated power consumption reduction amount to the network communicator 130 as power consumption information.

The panel control command generator 732 generates a signal for controlling the backlight of the display panel 200 in accordance with the attentiveness flag input from the attentiveness recognizer 720 and a later-described decision algorithm, and transmits the generated signal to the panel controller 210.

The audio/video output control command generator 733 outputs an audio/video output control signal to the audio/video output controller 120, which controls the audio and video outputs from the image display device 100, in accordance with the attentiveness flag input from the attentiveness recognizer 720 and the later-described decision algorithm.

The controller 731 selects either the normal mode or the power saving mode for the purpose of controlling the panel control command generator 732 and the audio/video output control command generator 733 in accordance with the control command issued by the system controller 110 and the attentiveness flag input from the attentiveness recognizer 720.

It should be noted that switching between the normal mode and the power saving mode may be made variously for the panel control command generator 732 and the audio/video output control command generator 733.

The power consumption reduction amount recorder 734 measures and records the power consumption reduction amount of the image display device 100 depending on how the controller 731 controls the panel control command generator 732 and the audio/video output control command generator 733. The recorded power consumption reduction amount is output to the network communicator 130 as the power consumption information.

The power consumption reduction amount can be measured, for instance, by performing the operation described below. First of all, information indicative of the power consumption reduction amount per unit time of each of plural control states for the panel control command generator 732 and the audio/video output control command generator 733 is tabulated and stored. Next, the controller 731 measures the elapsed time of each control state. The power consumption reduction amount of each control state is then calculated by multiplying the measured elapsed time of each control state by the power consumption reduction amount per unit time of each control state, which is indicated by the tabulated information. Finally, the calculated power consumption reduction amounts are added up to determine the power consumption reduction amount of the image display device 100.

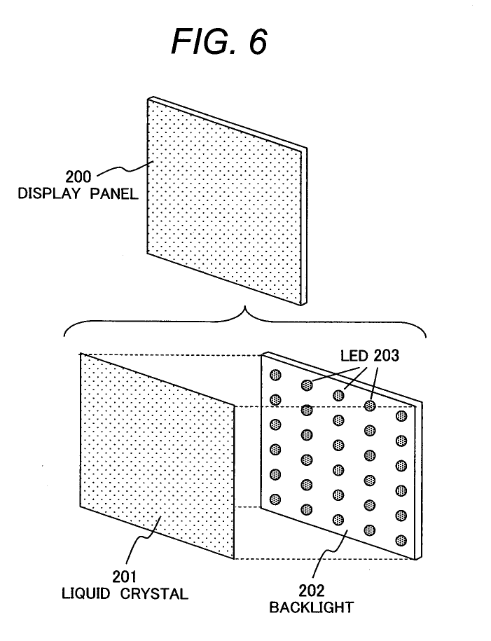

FIG. 6 shows a physical configuration of the display panel 200. The display panel 200, which displays images, includes a liquid crystal 201 and a backlight 202. The liquid crystal 201 is positioned in front of the backlight 202 to express an image. The backlight 202 is positioned behind the liquid crystal 201 to adjust the brightness of the image. The display panel 200 is formed by attaching the backlight 202 to the liquid crystal 201. LEDs 203 are discretely disposed on the backlight 202 so that illuminance variability can be partially provided for the image.

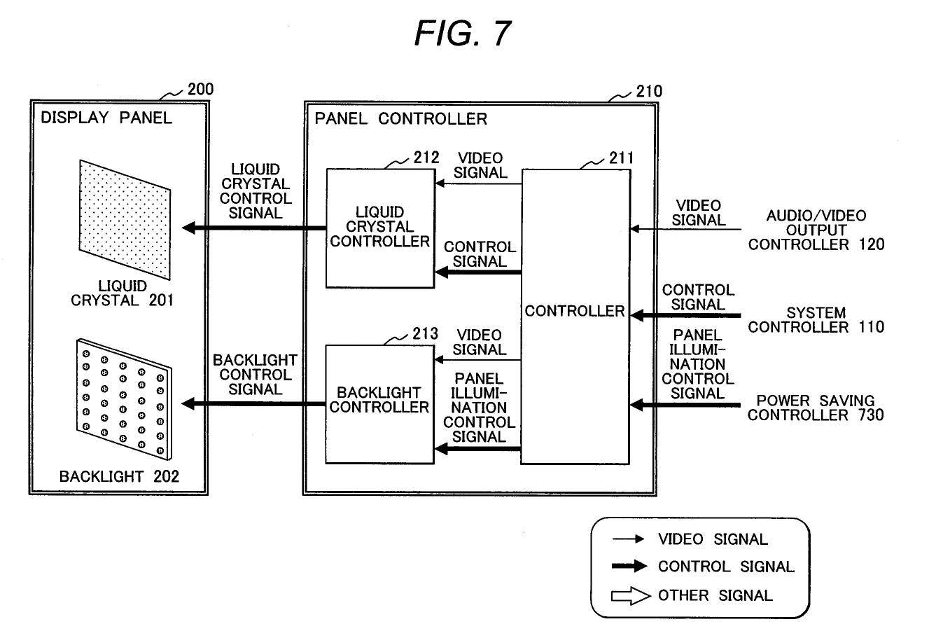

FIG. 7 shows typical configurations of the display panel 200 and the panel controller 210. As described above, the display panel 200 includes the liquid crystal 201 and the backlight 202.

The panel controller 210 controls the display operation of the display panel 200, and includes a controller 211, a liquid crystal controller 212, and a backlight controller 213. The controller 211 receives a video signal input from the audio/video output controller 120, a control signal input from the system controller 110, and a panel illumination control signal input from the power saving controller 730. The controller 211 outputs a video signal and a control signal to the liquid crystal controller 212, and a video signal and a panel illumination control signal to the backlight controller 213. The liquid crystal controller 212 generates a liquid crystal control signal from the input video signal and control signal, and outputs the generated liquid crystal control signal to the liquid crystal 201. The backlight controller 213 generates a backlight control signal from the input video signal and panel illumination control signal, and outputs the generated backlight control signal to the backlight 202. Input/output control for the above-mentioned inputs and outputs is repeatedly exercised at a video field signal time interval of 1/60 second.

A typical power saving control operation for the display panel 200, which is performed by the image display device 100, will now be described. When the panel controller 210 receives a panel extinguishment command or a panel dimming command from the power saving controller 730 as a panel illumination control command, the backlight controller 213 issues a backlight extinguishment or backlight dimming command as a backlight control signal to extinguish or dim the backlight for the purpose of minimizing or reducing the power consumption of the backlight no matter whether a video signal is received from the controller 211. When, on the other hand, the panel controller 210 receives a panel illumination command or a panel brightening command from the power saving controller 730 as a panel illumination control command, the backlight controller 213 exercises illumination control or brightening control of the backlight, as usual, in accordance with a video signal.

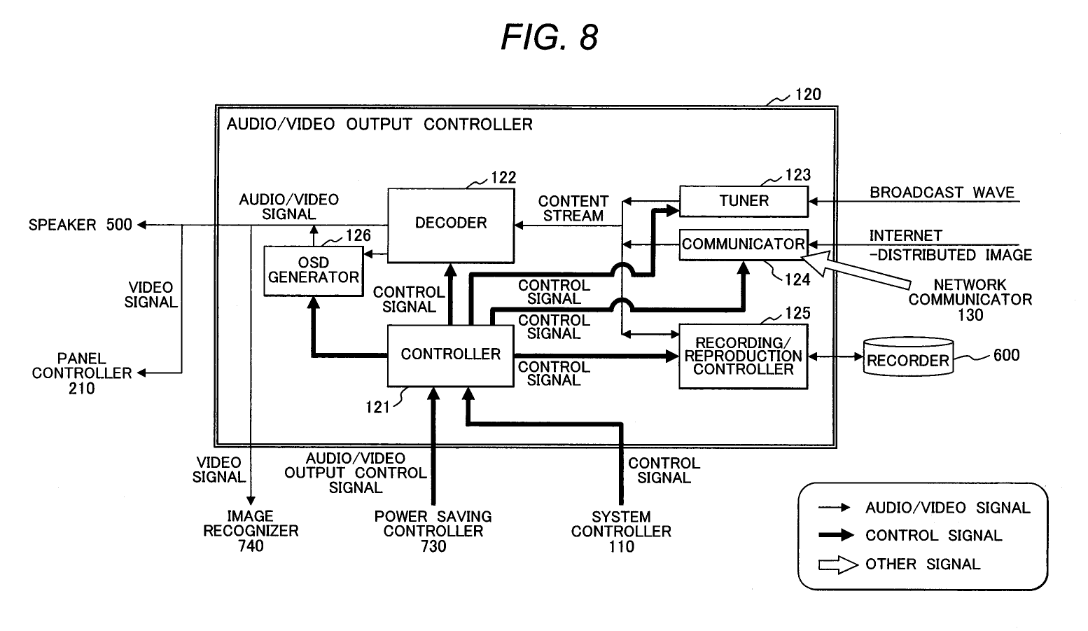

FIG. 8 shows a typical configuration of the audio/video output controller 120. The audio/video output controller 120 includes a controller 121, an audio/video decoder 122, a tuner 123, a communicator 124, and a recording/reproduction controller 125. The controller 121 controls the entire operation of the audio/video output controller 120 in accordance with a control signal from the system controller 110 and an audio/video output control signal from the power saving controller 730. The audio/video decoder 122 decodes an encoded video stream, for instance, a broadcast wave captured through the tuner 123, an Internet-distributed image acquired through the communicator 124, or an image recorded on the recorder 600, which is obtained through the recording/reproduction controller 125, converts the decoded result to an uncompressed audio/video signal, and outputs the uncompressed audio/video signal to the panel controller 210 and speaker 500.

A typical power saving control operation for audio/video output, which is performed by the image display device 100, will now be described. When, for instance, the user is not watching the image display device so that the controller 121 receives from the power saving controller 730 an audio/video control signal serving as a command for switching to the power saving mode, a control signal is issued to the audio/video decoder 122 to stop a video decoding process and decode audio only. The operation of the image display device 100 then changes so that only audio is output from the speaker 500. When, for instance, the user is watching the image display device so that the controller 121 receives from the power saving controller 730 an audio/video control signal serving as a command for switching to the normal mode, a control signal is issued to the audio/video decoder 122 to resume the video decoding process. The operation of the image display device 100 then changes so that both audio and video are output as usual.

Another typical power saving control operation for audio/video output, which is performed by the image display device 100, will now be described. When, for instance, the user leaves a room where the image display device is placed or falls asleep so that the power saving mode persists for a period of longer than predefined, it is possible to not only stop the video decoding process, but also use the following method to temporarily halt the reproduction of video and resume the reproduction of video when the user is watching the image display device again.

When the employed video source is an Internet-distributed image or an image recorded on the recorder 600, a video stream acquisition stop command is sent as a control signal to the communicator 124 and recording/reproduction controller 125 to temporarily halt the output of audio and video. In this instance, halt position information is recorded in the controller 121. When, for instance, the user is watching the image display device again so that an audio/video control signal serving as a command for switching to the normal mode is received from the power saving controller 730, a control signal serving as a video stream acquisition command is sent to the communicator 124 and recording/reproduction controller 125 to reproduce the audio and video from the previous halt position in accordance with the recorded halt position information. If a reproduction operation has been stopped for an extended period of several hours or longer, a message indicating, for instance, that the reproduction of a piece of content has been interrupted may be displayed without immediately resuming the reproduction operation to let the user choose to resume the reproduction operation or switch to another channel.

When the employed video source is a broadcast program derived from the tuner 123, the broadcast program is recorded on the recorder 600 instead of halting the reproduction of a video stream. This recording operation may be performed for a user-specified period of time or till the end of the broadcast program. When, for instance, the user is watching the image display device again so that an audio/video control signal serving as a command for switching to the normal mode is received from the power saving controller 730, a reproduction operation is performed in the same manner as for the aforementioned recorded image.

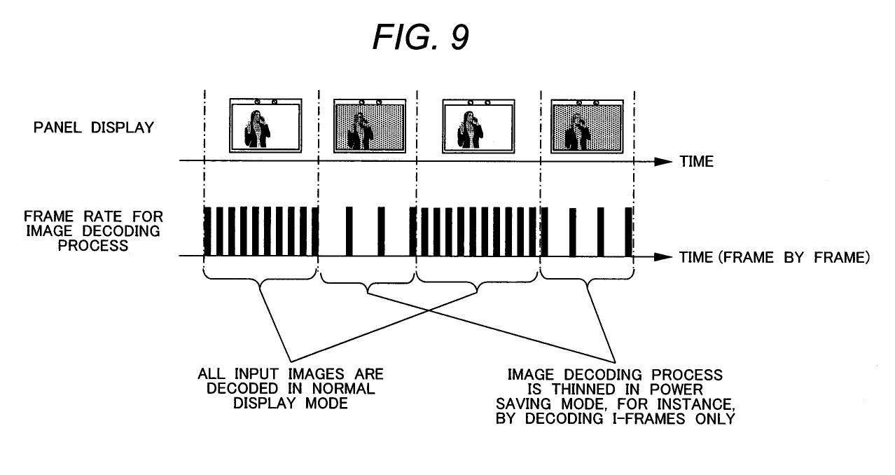

Another typical power saving control operation for audio/video output, which is performed by the image display device 100, will now be described. FIG. 9 shows an example of control that is exercised to prevent the delay of reproduction when reverting to the normal mode from the power saving mode. An example of control that is exercised to halt a video decoding process was described with reference to FIG. 8. In the example shown in FIG. 9, however, a delay of up to about 0.5 second occurs when reverting to the normal mode from the power saving mode. The reason is that almost all video sources are standardized in accordance with the MPEG-2 coding standard or H.264 broadcast standard. More specifically, the coding methods provided by these standards compress information on the basis of similarity (correlation) between neighboring frame images forming a moving picture. These standards state that one GOP (a group of pictures), which represents a minimum unit time of compression, is 0.5 second. Particularly when a decoding process is to be performed for reproduction purposes during the use of a broadcast wave, it is necessary to wait for a period of up to 0.5 second before acquiring the next GOP of a video stream given by way of the tuner 123. This is why the aforementioned delay occurs.

The above delay can be avoided by storing the nearest video stream in a buffer or the like without having to perform a decoding process, decoding only an I-frame image, which is the leading frame of a GOP, as shown in FIG. 9, feeding the decoded I-frame image into the panel controller 210, and allowing the liquid crystal 201 to reproduce only the I-frame image at a low frame rate. While the backlight is extinguished, the reproduced I-frame image does not appear on the screen of the image display device. However, when the user is watching the image display device again, thereby illuminating the backlight, the user can view the latest I-frame image of target video. This makes it possible to prevent the user from becoming impressed that the user has to wait for the display of an image due to low response.

As a still another typical power saving control operation for audio/video output, individual frames may be sequentially decoded beginning with the leading frame upon receipt of a decoding start command. This operation may be repeated until the PTS (Presentation Time Stamp), which is the time information attached to each frame, synchronizes with reproduced audio. In this instance, it is necessary to adopt such a configuration that the audio/video decoder 122 can operate faster than a display rate of 60 fields per second.

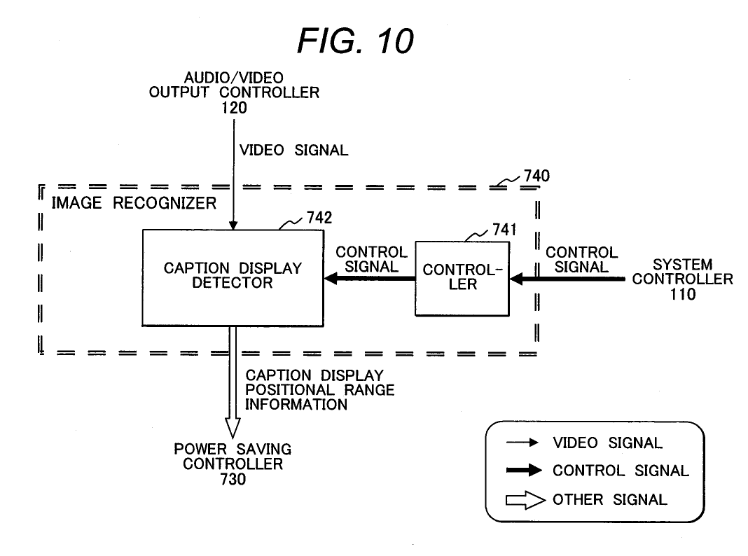

FIG. 10 shows a typical configuration of the image recognizer 740. The image recognizer 740 includes a controller 741 and a caption display detector 742. The image recognizer 740 receives a control signal, which indicates whether or not to detect a displayed caption, from the system controller 110, and controls the caption display detector 742 accordingly. The caption display detector 742 recognizes a broadcast image displayed on the display panel, detects the position and range of a caption display area, performs calculations to obtain caption display positional range information, and conveys the obtained information to the power saving controller 730.

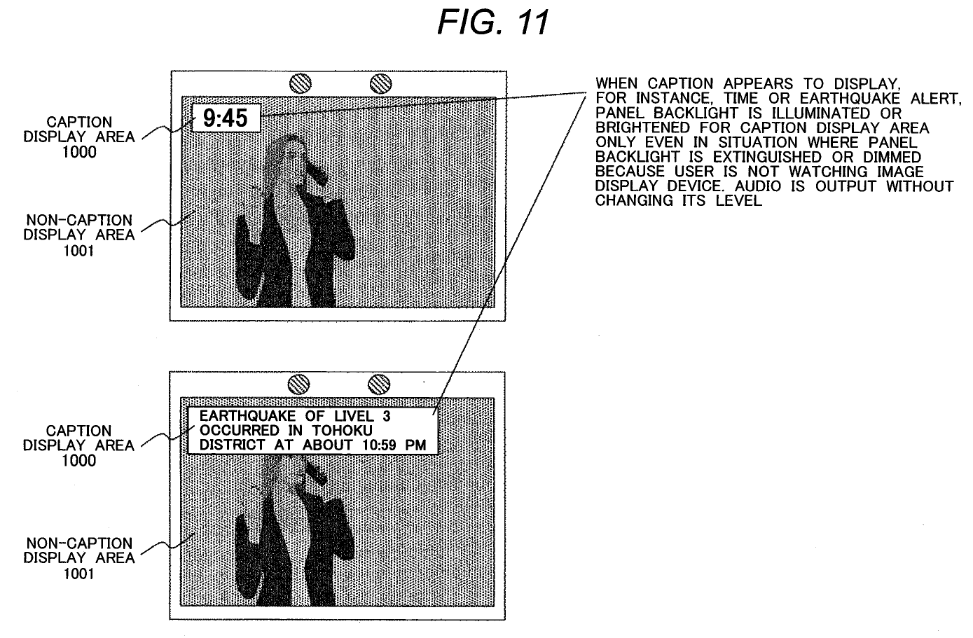

FIG. 11 shows an example of caption display control that is exercised while the backlight is extinguished or dimmed. The power saving controller 730 controls the following operation in accordance with the caption display positional range information. First of all, certain information should be constantly displayed in the caption display area 1000, which is included in the image display area, no matter whether the power saving mode prevails. For example, the caption display area 1000 should display an earthquake or tsunami alert and the current time in the upper left corner of the screen of the image display device. When the image display device switches to the power saving mode during the display of such information, the backlight for the entire screen is not simply extinguished or dimmed. Instead, the LEDs 203 for the backlight 202 that correspond to the caption display area 1000 detected by the image recognizer 740 remain illuminated without changing their brightness, whereas the LEDs 203 for the backlight 202 that correspond to the non-caption display area 1001 become extinguished or dimmed. This ensures that the caption display area remains displayed in the same manner as in a normal display state to maintain user-friendliness, and that the non-caption display area becomes extinguished or dimmed to achieve power consumption reduction. In the caption display area, relatively small image changes occur with time. Therefore, its display operation can be performed without causing any discomfort to the user even when the audio/video output controller 120 persistently exercises decoding process control for the power saving mode (without shortening the processing intervals). In this instance, the power consumption of the audio/video output controller 120 can be reduced to the same extent as when the entire backlight is extinguished or dimmed.

When the example shown in FIGS. 10 and 11 is described above, it is assumed that the image recognizer 740 detects the caption display area, performs calculations, and causes the power saving controller 730 to extinguish or dim the backlight for the caption display area in one manner and the backlight for the other area in another manner. However, an alternative configuration may be employed to simply display time information included in a broadcast signal or internal management time information of the image display device 100 within a predetermined display area, illuminate or brighten the backlight for the predetermined display area, and extinguish or dim the backlight for the other area. In this instance, it is possible to increase power savings with increased ease and notify the user of time without having to perform an image recognition process.

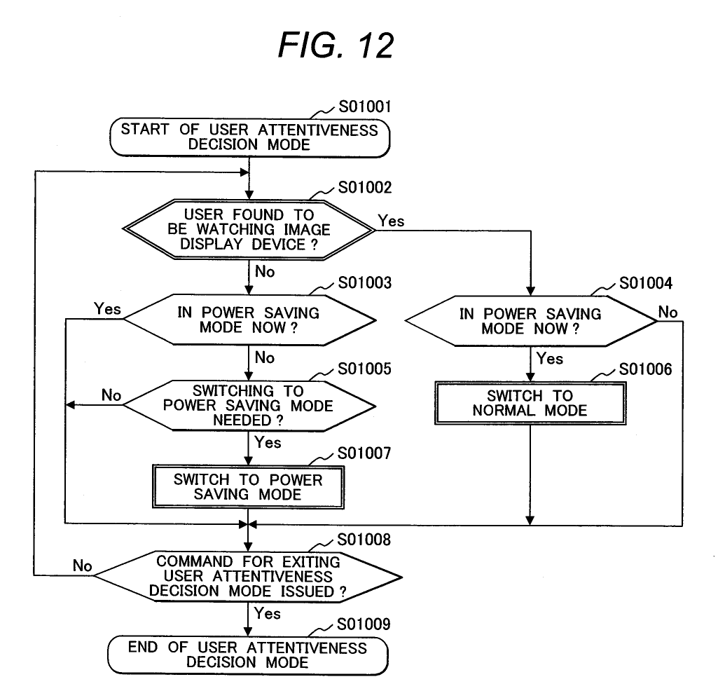

FIG. 12 is a flowchart illustrating how the image display device 100 performs an image display power saving control operation on the basis of attentiveness decision.

First of all, the user operates the remote controller 300 to issue an instruction for entering a user attentiveness decision mode and initiate a power saving operation. The system controller 110 transmits a control signal for entering the user attentiveness decision mode to the attentiveness recognizer 720, power saving controller 730, image recognizer 740, and panel controller 210, and starts a power saving operation based on a user attentiveness decision (step S01001).

The attentiveness recognizer 720 acquires a user image from the camera 700 and judges whether the user is watching the image display device (step S01002). The result of judgment is output to the power saving controller 730 in the form of an attentiveness flag. If the user is not found to be watching the image display device, the power saving controller 730 performs a process for switching to the power saving mode (step S01003). If, on the other hand, the user is found to be watching the image display device, the power saving controller 730 performs a process for switching to the normal mode (step S01004).

Next, the controller 731 or panel control command generator 732 in the power saving controller 730 judges whether the power saving mode is currently selected as the control mode (step S01003). If the power saving mode is currently selected, the image display device proceeds to step S01008. If, on the other hand, the power saving mode is not currently selected, the image display device performs step S01006 to judge whether it should switch to the power saving mode. If it is judged that the image display device should switch to the power saving mode, the image display device proceeds to step S01007 and performs a process for switching to the power saving mode. More specifically, a panel illumination control signal for extinguishing the display panel is output to the panel controller. After the signal is output, the image display device proceeds to step S01008. However, if it is judged that the image display device should not switch to the power saving mode, the image display device directly proceeds to step S01008.

On the other hand, when step S01004 is to be performed to switch to the normal mode, the controller 731 or panel control command generator 732 judges whether the power saving mode is currently selected as the control mode. If the power saving mode is currently selected, step S01006 is performed to switch to the normal mode. More specifically, a panel illumination control signal for illuminating the display panel is output to the panel controller. After the signal is output, the image display device proceeds to step S01008. However, if the power saving mode is not currently selected, the image display device directly proceeds to step S01008.

In step S01008, the image display device finally judges whether a command for exiting the user attentiveness decision mode is issued by the user. If the command is issued, the image display device proceeds to step S01009 and exits the user attentiveness decision mode. If the command is not issued, the image display device returns to step S01002 and repeats the subsequent steps.

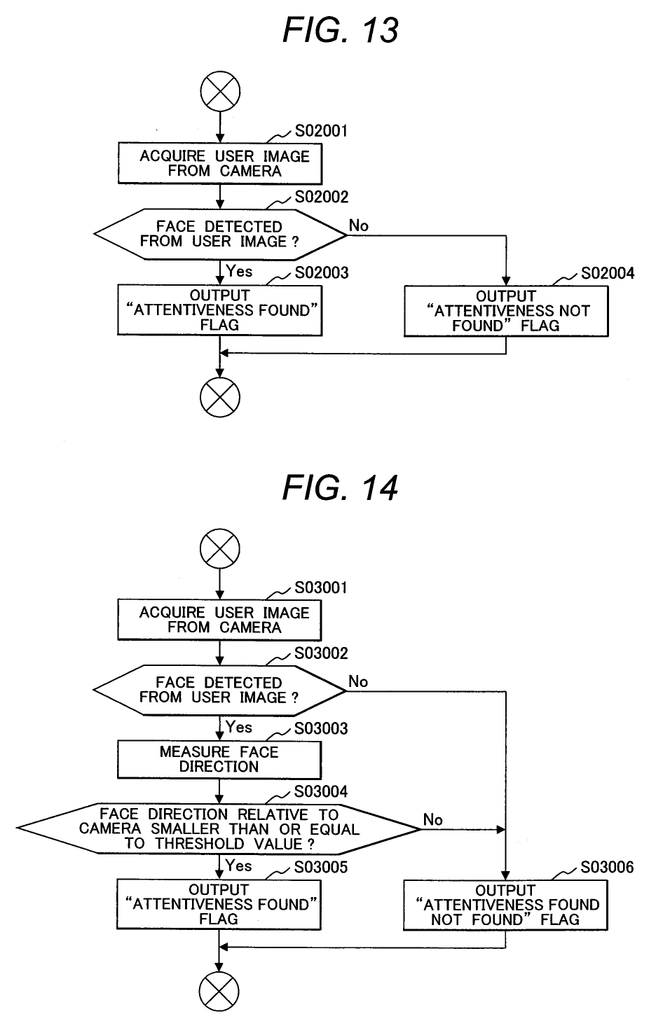

FIG. 13 is a flowchart illustrating an example of an attentiveness decision algorithm. This flowchart describes an operation of the face detector 722 in the attentiveness recognizer 720, or more specifically, the details of step S01002, which is shown in FIG. 12.

First of all, a user image is acquired from the camera 700 (step S02001). Next, a face detection process is performed on the user image to detect a face (step S02002). If a face is detected, the image display device judges that the user is watching the image display device, and proceeds to step S02003. If, on the other hand, a face is not detected, the image display device judges that the user is not watching the image display device, and proceeds to step S02004.

In step S02003, an “attentiveness found” flag is output to the power saving controller 730. In step S02004, on the other hand, an “attentiveness not found” flag is output to the power saving controller 730.

FIG. 14 is a flowchart illustrating another example of the attentiveness decision algorithm. This algorithm measures the direction of a user's face and judges whether the user is watching the image display device. This flowchart describes an operation of the face/line-of-sight angle calculator 723 in the attentiveness recognizer 720, or more specifically, the details of step S01002, which is shown in FIG. 12.

First of all, a user image is acquired from the camera 700 (step S03001). Next, a face detection process is performed on the user image to detect a face (step S03002). If a face is detected, the image display device proceeds to step S03003. If, on the other hand, a face is not detected, the image display device proceeds to step S03006.

In step S03003, the direction of the detected face is measured. The face direction can be measured by a method disclosed, for instance, in Japanese Patent Application Laid-Open Publication No. 2007-286995. As a face has three degrees of rotational freedom, three types of angular directions are obtained. Here it is assumed, however, that up-down and left-right face directions relative to the camera are measured.

Next, step S03004 is performed to judge whether the measured up-down and left-right face directions relative to the camera are smaller than predetermined threshold values. This step is equivalent to judging whether the user is facing the image display device. If the face directions relative to the camera are smaller than the threshold values, the image display device concludes that the user is watching the image display device, and then proceeds to step S03005. If, on the other hand, the face directions are greater than the threshold values, the image display device concludes that the user is not watching the image display device, and then proceeds to step S03006.

In step S03005, the “attentiveness found” flag is output to the power saving controller 730. In step S03006, on the other hand, the “attentiveness not found” flag is output to the power saving controller 730.

In the example shown in FIG. 14, the decision process calculates both the presence of a face and the direction of the face. This makes it possible to make an attentiveness decision with increased accuracy.

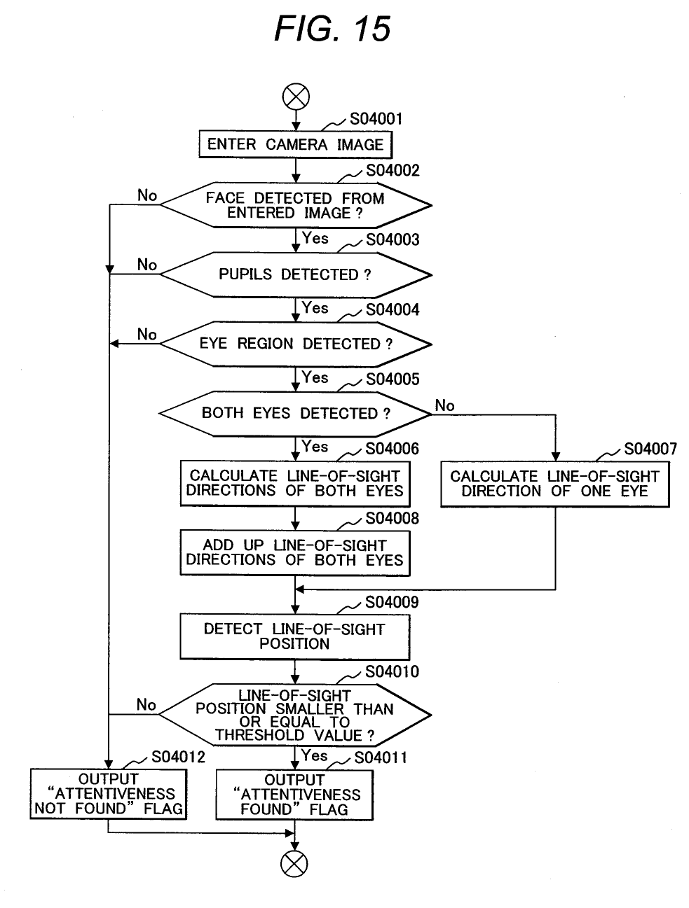

FIG. 15 is a flowchart illustrating another example of the attentiveness decision algorithm. This algorithm measures the direction of a user's line-of-sight and judges whether the user is watching the image display device. The line-of-sight can be measured by a method disclosed, for instance, in Japanese Patent Application Laid-Open Publication No.2007-286995. This flowchart describes operations of the face/line-of-sight angle calculator 723 and watched position calculator 724 in the attentiveness recognizer 720, or more specifically, the details of step S01002, which is shown in FIG. 12.

First of all, a user image is acquired from the camera 700 (step S04001). Next, a face detection process is performed on the user image to detect a face (step S04002). If a face is detected, the image display device proceeds to step S04003. If, on the other hand, a face is not detected, the image display device proceeds to step S04012.

In step S04003, a process is performed to detect pupils (or irises), which are easily detected. If pupils are detected, the image display device proceeds to step S04004. If, on the other hand, pupils are not detected, the image display device proceeds to step S04012.

In step S04004, an eye region detection process is performed as it is necessary for estimating an eyeball posture. The eye region detection process is performed on both the right and left eyes. If neither of the right and left eyes is detected, the image display device proceeds to step S04012. If both eyes are detected, the image display device proceeds to step S04006. If either the right or left eye is detected, the image display device proceeds to step S04007. In steps S04006 and 504007, the light-of-sight direction of each detected eye is determined. After completion of step S04006 step S04008 is performed to calculate the line-of-sight directions of both eyes and average the calculated directions, thereby determining the eye direction. Next, step S04009 is performed to detect a line-of-sight position in a virtually-expanded plane of the panel surface of the image display device from the distance information derived, for instance, from the sensor 710. Finally, step S04010 is performed to check whether the line-of-sight position is within a predetermined range. The result of the check indicates whether the user is watching the image display device. In step S04011, the “attentiveness found” flag is output to the power saving controller 730. In step S04012, on the other hand, the “attentiveness not found” flag is output to the power saving controller 730.

In the example shown in FIG. 15, the decision process calculates not only the presence and direction of a face but also the line-of-sight direction. This makes it possible to make an attentiveness decision with enhanced accuracy.

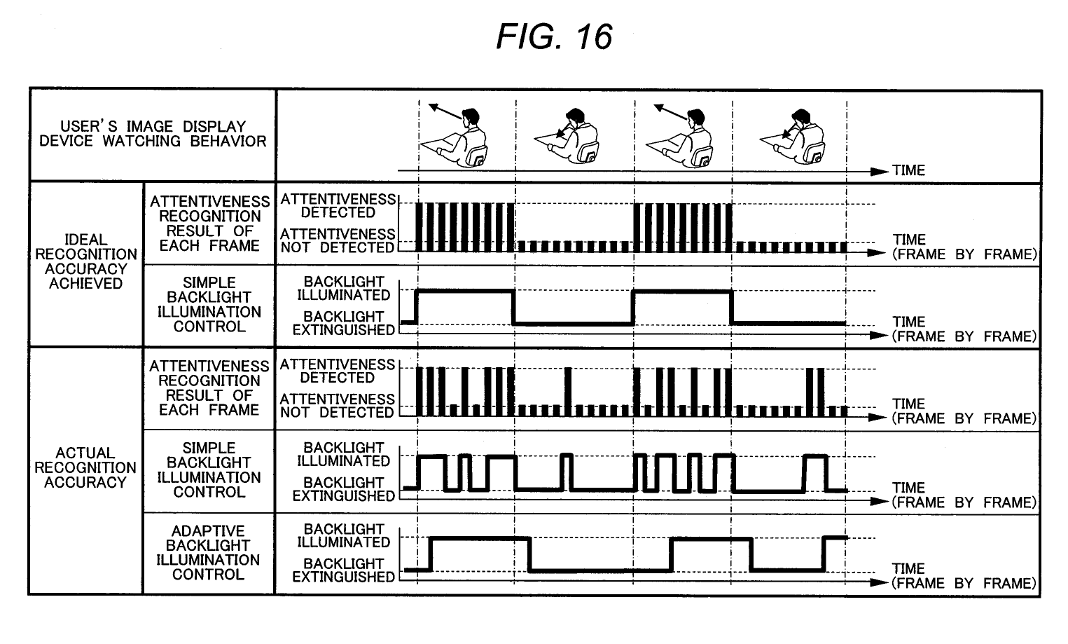

FIG. 16 is a table illustrating an example of backlight illumination control. The first row in the table indicates temporal changes in a user's image display device watching behavior. When the user's line-of-sight is directed upward in the first row, it means that the user is watching the image display device. When, on the other hand, the user's line-of-sight is directed downward, it means that the user is not watching the image display device. The second and third rows indicate the result of recognition of each frame, which is obtained when such user behaviors can be ideally recognized, and state transitions that occur when the backlight is illuminated or extinguished in accordance with the result of recognition. In a situation where ideal recognition accuracy is achieved, simple control is exercised to illuminate the display panel while the user is watching the image display device and extinguish the display panel while the user is not watching the image display device. Thus, the image display device can be subjected to power saving control without causing any stress to the user.

In reality, however, a recognition accuracy of 100% cannot be achieved. An actual recognition result often differs from an ideal one as indicated in the third row. In such an instance, a display panel illumination pattern shown in the fourth row may result as far as the display panel is simply turned on or off in accordance with the recognition of each frame. This may cause the image display device to extinguish the backlight frequently while the user is watching the image display device or illuminate the display panel while the user is not watching the image display device. Thus, the user becomes stressed. Consequently, the user might not want to use a power saving control feature based on user attentiveness decision.

However, the above problem can be addressed by exercising backlight illumination/extinguishment control, which is based on a predefined decision control scheme, in relation to the attentiveness recognition result of each frame as indicated in the fifth row. A typical decision control scheme is to preset a first threshold value indicative of a frame count or a period of time, illuminate the display panel when attentiveness is detected successively for a frame count or a period of time that exceeds the first threshold value, and extinguish the display panel when inattentiveness is detected successively for a frame count or a period of time that exceeds a second threshold value. Although this scheme illuminates and extinguishes the display panel with a slight delay relative to a user action, it is possible to prevent the backlight from turning on and off at frequent intervals. Consequently, it is possible to provide user-friendliness and achieve power saving in accordance with attentiveness decision.

When the above description is given with reference to FIG. 16, it is assumed that backlight illumination/extinguishment control is exercised. Alternatively, however, backlight brightening/dimming control may be exercised in a similar manner. When such an alternative control scheme is employed, the terms “illumination” and “extinguishment” in the above description given with reference to FIG. 16 should be changed to “brightening” and “dimming,” respectively.

When the above description is given with reference to FIG. 16, it is assumed that backlight illumination/extinguishment control is exercised. However, when a power saving control operation is performed for audio/video output, which is described with reference to FIGS. 8 and 9, predefined decision control may be exercised similarly by using the threshold values described with reference to FIG. 16. In such an instance, it is also possible to provide user-friendliness and achieve power saving in accordance with attentiveness decision.

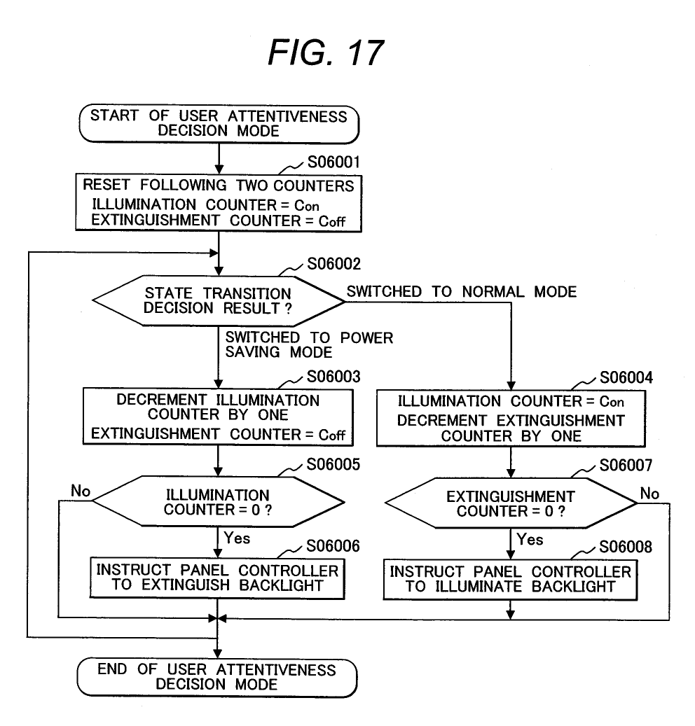

FIG. 17 is a flowchart illustrating an operation that is performed while backlight illumination/extinguishment control is exercised as indicated by the example of FIG. 16. The operation described below is performed by the controller 731 or the panel control command generator 732.

First of all, a process starts when the controller 731 in the power saving controller 730 receives a control signal for entering the user attentiveness decision mode.

The controller 731 or the panel control command generator 732 resets, for instance, its two internal counters, namely, an illumination counter and an extinguishment counter, to predetermined values Cₒₙ and C_{off}, respectively (step S06001). The image display device then proceeds to step S06002 and checks the state transition decision result obtained as described with reference to FIG. 12. If the state transition decision result indicates a transition to the power saving mode, the image display device proceeds to step S06003. If, on the other hand, the state transition decision result indicates a transition to the normal mode, the image display device proceeds to step S06004.

In step S06003, the image display device decrements the illumination counter by one, resets the extinguishment counter again, and proceeds to the next step. In step S06005, the image display device checks whether the illumination counter is zero. If the illumination counter is zero, the image display device proceeds to step S06006. If, on the other hand, the illumination counter is not zero, the image display device returns to step S06002. In step S06006, the image display device instructs the panel controller 210 to extinguish the backlight, and then returns to step S06002.

In step S06004, on the other hand, the image display device decrements the extinguishment counter by one, resets the illumination counter again, and proceeds to the next step. In step S06007, the image display device checks whether the illumination counter is zero. If the illumination counter is zero, the image display device proceeds to step S06008. If, on the, other hand, the illumination counter is not zero, the image display device returns to step S06002. In step S06008, the image display device instructs the panel controller 210 to illuminate the backlight, and then returns to step S06002.

Performing the above operation makes it possible to provide backlight illumination/extinguishment control while minimizing the stress applied to the user as described with reference to FIG. 16.

When the above description is given with reference to FIG. 17, it is assumed that backlight illumination/extinguishment control is exercised. Alternatively, however, backlight brightening/dimming control may be exercised in a similar manner. When such an alternative control scheme is employed, the terms “illumination” and “extinguishment” in the above description given with reference to FIG. 17 should be changed to “brightening” and “dimming,” respectively.

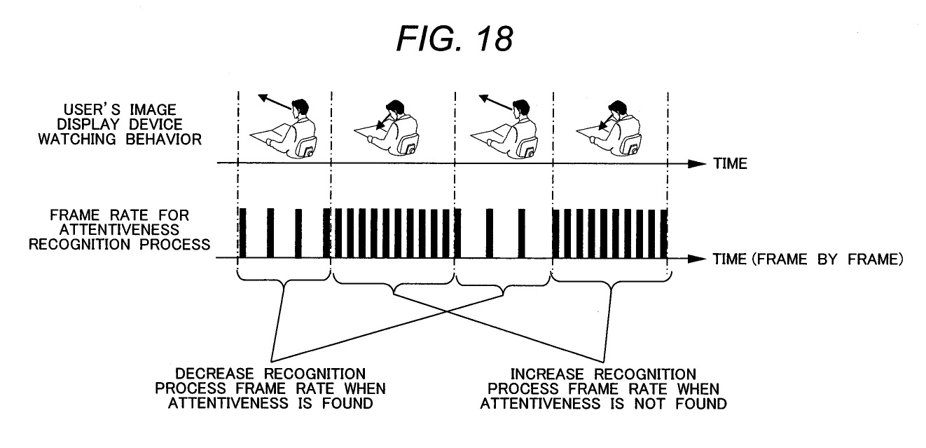

FIG. 18 is a diagram illustrating an example of control that is exercised to further reduce the power consumption of the attentiveness recognizer 720. When the user's line-of-sight is directed upward in FIG. 18, it means that the user is watching the image display device. When, on the other hand, the user's line-of-sight is directed downward, it means that the user is not watching the image display device.

The attentiveness recognizer 720 basically processes an image input from the camera and judges whether the user is watching the image display device. From the viewpoint of the responsiveness of attentiveness decision, it is preferred that the attentiveness recognizer 720 be capable of processing the input image at the same frequency as the frame rate of the camera wherever possible. From the viewpoint of power consumption reduction, however, it is preferred that the amount of processing be reduced. Thus, it is possible to achieve power consumption reduction and maintain an adequate response speed for switching from the power saving mode to the normal mode by changing the camera's frame rate for user status sampling depending on whether the power saving mode or the normal mode currently prevails.

Consequently, when the user is watching the image display device (in the normal mode), an attentiveness recognition process is performed at a low frame rate to reduce the power consumption required for the attentiveness recognition process. Although the resulting response speed for backlight extinguishment is slightly lowered when the user stops watching the image display device, it does not constitute any practical problem because the user is watching something else. Meanwhile, when the user is not watching the image display device (in the power saving mode), the attentiveness recognition process is performed at a high frame rate. This makes it possible to minimize the degradation of user-friendliness by increasing the response speed for illuminating or brightening the backlight.

In other words, it is possible to reduce the power consumption required for attentiveness recognition processing without sacrificing user-friendliness by performing the attentiveness recognition process at a lower frequency when the user is watching the image display device than when the user is not watching the image display device.

An alternative configuration may be employed so that the remote controller 300 includes a button for issuing a command for switching from the power saving mode to the normal mode. When the button is pressed to issue the above command during the use of this alternative configuration, the image display device 100 switches to the normal mode. In this alternative configuration, the user can force the image display device 100 to enter the normal mode if the image display device 100 remains in the power saving mode when the user is watching the image display device 100. This makes it possible to alleviate user discomfort even when the image display device 100 remains in the power saving mode due to an unexpected circumstance.

Another alternative configuration may be employed so that the remote controller 300 includes a vibration sensor or an orientation sensor. When the vibration sensor or orientation sensor detects vibration or a change in orientation while the image display device is in the power saving mode during the use of this alternative configuration, the sensor may output an instruction for switching from the power saving mode to the normal mode, thereby causing the image display device to switch to the normal mode in accordance with the instruction. When the user operates the remote controller, it is highly probable that the user is watching or is about to watch the image display device. Therefore, this alternative configuration makes it possible to prevent the image display device from remaining in the power saving mode or switching to the normal mode with a significant delay when the user is watching the image display device.

Another alternative is to let the image display device 100 illuminate or brighten a part of the backlight in the power saving mode and display a character string or a pictorial figure in the illuminated or brightened part to indicate that image display device is in the power saving mode. This certainly notifies the user whether the image display device is turned off or is turned on and placed in the power saving mode. Further, instead of illuminating or brightening a part of the backlight to display a character string or a pictorial figure, the image display device may alternatively include a second display, which is smaller than the display panel 200, and display a character string or a pictorial figure on the second display to indicate that image display device is in the power saving mode. Another alternative is to provide the image display device 100 with a small-size LED light source or the like and illuminate it or change its light color to indicate that the image display device is in the power saving mode.

Another alternative is to let the image display device 100 illuminate or brighten a part of the backlight in the power saving mode and display a character string or a pictorial figure in the illuminated or brightened part to indicate a power consumption reduction amount stored in the power consumption reduction amount recorder 734 or present power consumption reduction amount information calculated from the stored power consumption reduction amount. This enables the user to grasp the amount of power consumption reduction. Instead of illuminating or brightening a part of the backlight to display a character string or a pictorial figure, the image display device may alternatively include a second display, which is smaller than the display panel 200, and display a character string or a pictorial figure on the second display to indicate the power consumption reduction amount or the information about it.

The image display device according to the above-described embodiment of the present invention makes it possible to exercise power consumption reduction control in an improved manner.

It should be understood by those skilled in the art that various modifications, combinations, sub-combinations, and alterations may occur depending on design requirements and other factors insofar as they are within the scope of the appended claims or the equivalents thereof.

What is claimed is:

1. An image display device comprising:
an input that inputs a video signal;
an output controller that reproduces the video signal entered into the input;
a display that displays an image in accordance with the video signal reproduced by the output controller;
an imager that picks up an image of a user of the image display device;
an attentiveness decider that analyzes the image picked up by the imager and judges whether the user is watching a display screen of the display; and
a controller that selects either a normal mode or a power saving mode as a processing mode for light intensity control of a light source of the display or for reproduction in the output controller in accordance with the result of decision made by the attentiveness decider.

2. The image display device according to claim 1, wherein, when the processing mode for light intensity control of the light source of the display is changed from the normal mode to the power saving mode, the controller exercises control so as to extinguish the light source or provide the light source for the entire display screen or a part of the display screen of the display with lower light intensity than in the normal mode.

3. The image display device according to claim 2, wherein the attentiveness decider detects the face direction or the line-of-sight direction of the user from the image picked up by the imager, and concludes that the user is watching the display screen of the display when the detected direction does not exceed a threshold range, or that the user is not watching the display screen of the display when the detected direction exceeds the threshold range.

4. The image display device according to claim 1, wherein, when the attentiveness decider concludes for a predetermined period of time that the user is not watching the display screen, the controller switches the processing mode for light intensity control of the light source of the display or for reproduction in the output controller from the normal mode to the power saving mode.

5. The image display device according to claim 1, wherein the video signal entered into the input is an encoded video signal, the encoded video signal containing an intraframe predictive image and an interframe predictive image; and wherein the output controller reproduces only the intraframe predictive image in the power saving mode.

6. The image display device according to claim 1, wherein the input receives an input video signal and an input audio signal; wherein the output controller reproduces both the video signal and the audio signal, includes an audio output that outputs the audio signal reproduced by the output controller; and wherein, when the controller switches the processing mode for reproduction in the output controller from the normal mode to the power saving mode, the output controller stops a process for reproducing the video signal and continuously performs a process for reproducing the audio signal.

7. The image display device according to claim 1, wherein the attentiveness decider performs a process for judging whether the user is watching the display screen of the display at a lower frequency in the normal mode than in the power saving mode.

8. The image display device according to claim 1, further comprising:
an external control signal input that inputs a control signal coming from the outside;
wherein the control signal instructs the controller to switch from the power saving mode to the normal mode.

9. The image display device according to claim 8, wherein the control signal is input into the external control signal input from an external terminal having a vibration sensor or an orientation sensor; and wherein, when the vibration sensor detects vibration or when the orientation sensor detects a change in orientation, a control signal that gives an instruction for switching from the power saving mode to the normal mode is input from the external terminal to the external control signal input.

10. The image display device according to claim 1, wherein, when the power saving mode prevails, the output controller causes the display to present text information or graphic information indicating that the image display device is in the power saving mode.

11. The image display device according to claim 1, wherein, when the power saving mode prevails, the output controller causes the display to present text information or graphic information indicating a power consumption reduction amount, the text information or the graphic information being superimposed on a video signal.

12. The image display device according to claim 2, further comprising:
a caption display area calculator that calculates a caption information display area of the display, the caption information display area displaying caption information superimposed on an image contained in the video signal entered into the input or caption information entered into the input together with the video signal;
wherein, when the power saving mode prevails, the controller ensures that the light intensity of a light source for the caption information display area calculated by the caption display area calculator is higher than the light intensity of the other light source.

13. The image display device according to claim 2, wherein, when the power saving mode prevails, the output controller displays current time information on the display in the power saving mode.

14. The image display device according to claim 1, further comprising:
a network communicator that exchanges data with a data center server through the Internet;
wherein the controller includes a recorder that records power consumption reduction amount information, which indicates the amount of power consumption reduction achieved in the power saving mode;
wherein the network communicator transmits the power consumption reduction amount information recorded in the recorder to the data center server and receives total power consumption reduction information from the data center server, the total power consumption reduction information being obtained by summing up power consumption reduction amount information received from a plurality of image display devices connected to the data center server through the Internet; and
wherein the display presents information about the amount of power consumption reduction achieved by the plurality of image display devices in accordance with the total power consumption reduction information.
